(19) United States
(12) Patent Application Publication
(10) Pub. No.: US 2020/0064443 A1
(43) Pub. Date: Feb. 27, 2020

(54) METHOD OF IDENTIFYING AND NEUTRALIZING LOW-ALTITUDE UNMANNED AERIAL VEHICLE

(71) Applicant: Sung Wook Yoon, Seoul (KR)

(72) Inventor: Sung Wook Yoon, Seoul (KR)

(21) Appl. No.: 16/440,916

(22) Filed: Jun. 13, 2019

(30) Foreign Application Priority Data
Aug. 21, 2018 (KR) 10-2018-0097384
May 7, 2019 (KR) 10-2019-0053159

(51) Int. Cl. G01S 7/41; B64C 39/02; B64F 1/22; F41H 11/00; H04K 3/00; G01S 7/52

(52) U.S. Cl. CPC G01S 7/411; B64C 39/024; B64F 1/22; B64C 2201/22; H04K 3/825; G01S 7/52017; B64C 2201/145; F41H 11/00

(57) ABSTRACT

Disclosed is a method of identifying and neutralizing a low-altitude unmanned aerial vehicle. According to an embodiment, a low-altitude unmanned aerial vehicle identification system is configured to set monitoring airspace for a low altitude warning system, and to determine an abnormal signal generated in the monitoring airspace and a hostile target through low-altitude unmanned aerial vehicle identification information that contains a radar signal, an RF signal, an image signal, a sound signal, UAV shape information, and a communication signal in the set monitoring airspace. Further, correspondingly, GPS jamming, control signal jamming, gyro sensor jamming, spoofing, and the like are disclosed as neutralization methods.

### CROSS REFERENCE TO RELATED APPLICATION

This application is based on and claims priority from Korean Patent Applications Nos. 10-2018-0097384 filed on Aug. 21, 2018 and 10-2019-0053159 filed on May 7, 2019 in the Korean Intellectual Property Office, the disclosure of which is incorporated herein in its entirety by reference.

### BACKGROUND OF THE INVENTION

### Field of the Invention

The present invention relates generally to a method and a system for identifying an unmanned aerial vehicle. More particularly, the present invention relates to a method of identifying and neutralizing an unmanned aerial vehicle for low-altitude unmanned aerial vehicle identification and abnormal target determination in low-altitude airspace.

Description of the Related Art

Unless otherwise indicated herein, the contents set forth in this section are not prior art to the claims of this application and are not to be construed as being prior art to be included in this section.

Due to the innovative development of science and technology, the aspect of war between nations is changing. In particular, the rapid development of communication and network systems, along with the rapid development of IT, software, and media technologies, is affecting the entire weapons and logistics system, and with the development of science and technology, the threat of North Korea has been diversified recently. North Korea is constantly causing low-intensity conflicts with new forms of irregular warfare such as attempts to conduct surveillance by small unmanned aerial vehicles (UAVs) and cyber terrorism, as well as asymmetric threats such as the development of nuclear weapons and ballistic missile launch tests. In such a future battleground environment, the role of the unmanned weapon system that can carry out dangerous missions and minimize the loss of human lives will increase.

Especially, it is anticipated that three-dimensional warfare, where manned and unmanned systems are integrated, will be developed utilizing the low-altitude airspace (equal to or less than 20,000 ft) in which spatial movement is relatively free, such as launching low-altitude penetration and surveillance/reconnaissance activities by small UAVs.

UAVs vary in size and operating area from ultra-small UAVs that are about 15 cm in size and can be maneuvered by hand to large UAVs that can be operated at altitudes of over 45,000 ft. As the application range and application fields in the private sector become wider, demand has increased and thus various types of UAVs have been developed, and civilians can easily operate UAVs. As a result, the possibility of terrorism using an UAV has also increased.

In addition, recently released hoverbike technology can easily allow access to major facilities by an unspecified number of people, thereby increasing the possibility of sporadic terrorism such as small bombs and IED terrorism. In Korea, more than 70% of the country is a mountainous region, and particularly, most of the front areas bordering North Korea are rugged mountainous areas with high peaks.

This means that the above ground level (AGL) is also very irregular depending on the terrain, which is highly likely to degrade the detection capability due to terrain masking when operating ground-based low altitude acquisition radar. Therefore, in order to overcome this, it is required to operate an effective surveillance/detection system other than the ground-based radars, which can detect infiltrating aircrafts in low-altitude tactical flight.

The foregoing is intended merely to aid in the understanding of the background of the present invention, and is not intended to mean that the present invention falls within the purview of the related art that is already known to those skilled in the art.

### DOCUMENT OF RELATED ART

Korean Patent No. 10-1572184 (Nov. 20, 2015)

### SUMMARY OF THE INVENTION

Accordingly, the present invention has been made keeping in mind the above problems occurring in the related art, and the present invention is intended to propose a method of identifying and neutralizing a low-altitude unmanned aerial vehicle, in which monitoring airspace for a low altitude warning system is set, and an abnormal signal generated in the monitoring airspace and an enemy target are determined through low altitude UAV identification information including a radar signal, an RF signal, a sound signal, shape information, and a communication signal of the set monitoring airspace.

In order to achieve the above object, according to one aspect of the present invention, there is provided a method of identifying and neutralizing a low-altitude unmanned aerial vehicle for a low-altitude unmanned aerial vehicle identification system, the method including: (A) building a database by registering sound and shape information of each low-altitude unmanned aerial vehicle type; (B) setting monitoring airspace for a low altitude warning system and collecting low-altitude unmanned aerial vehicle identification information that contains a radar signal, an RF signal, a sound signal, and a communication signal in the set monitoring airspace; (C) determining whether an abnormal signal exceeding a predetermined level in the prestored sound and shape information of each unmanned aerial vehicle type is contained in the collected identification information; (D) taking, when the abnormal signal is contained in the collected identification information, a low-altitude unmanned aerial vehicle target image of the low-altitude unmanned aerial vehicle that generates the abnormal signal, and transmitting the low-altitude unmanned aerial vehicle target image to a ground control center and a low-altitude air warning center; (E) comparing, by the low-altitude air warning center, sound and shape information included in the unmanned aerial vehicle target image with the prestored sound and shape information of each unmanned aerial vehicle type; (F) determining whether the unmanned aerial vehicle is an abnormal target according to a result of the comparison; (G) checking, when the unmanned aerial vehicle is determined as the abnormal target, whether the unmanned aerial vehicle is a hostile target; (H) controlling an interceptor system when the abnormal target is the hostile target.

According to the present invention, an abnormal signal is identified by sound information and shape information of UAV types, so it is possible to overcome terrain masking that is the limit of conventional detectors and overcome a detection blind zone in low altitude airspace, and by combining sound-based sensor, electro-optical sensor, and infrared sensor, it is possible to collect communication and sound data more accurately in the monitoring area. In addition, when the low altitude UAV identification system is operated in conjunction with ground interceptor and attack system, the identification system can be used as an effective anti-aircraft weapon system capable of real-time attack.

It should be understood that the effects of the present invention are not particularly limited to those described above, and the present invention includes all effects that can be deduced from the detailed description of the invention or the configurations of the invention described in the appended claims.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a conceptual flowchart illustrating operation of a low-altitude unmanned aerial vehicle warning system according to an embodiment;

FIG. 2 is a flowchart illustrating steps of jamming a wireless control signal as a neutralization method according to an embodiment;

FIG. 3 is a flowchart illustrating steps of jamming a GPS signal as a neutralization method according to an embodiment;

FIG. 4 is a flowchart illustrating steps of jamming a gyro sensor as a neutralization method according to an embodiment;

FIG. 5 is a flowchart illustrating steps of spoofing a GPS signal as a neutralization method according to an embodiment; and

FIG. 6 is a diagram illustrating types of physical neutralization as a neutralization method according to an embodiment.

### DETAILED DESCRIPTION OF THE INVENTION

Advantages and features of the present invention, and methods to achieve them will be apparent from the following embodiments that will be described in detail with reference to the accompanying drawings. It should be understood that the present invention is not limited to the following embodiments and may be embodied in different ways, and that the embodiments are given to provide complete disclosure of the invention and to provide a thorough understanding of the present invention to those skilled in the art. The scope of the present invention is defined only by the claims. Throughout the description, the same reference numerals refer to same elements.

In the following description, it is to be noted that, when the functions of conventional elements and the detailed description of elements related with the present invention may make the gist of the present invention unclear, a detailed description of those elements will be omitted. Further, the terms described below are defined in consideration of the functions in the embodiments of the present invention, which may vary depending on the intention of the user, the operator, or the custom. Therefore, the definition should be based on the contents throughout this specification.

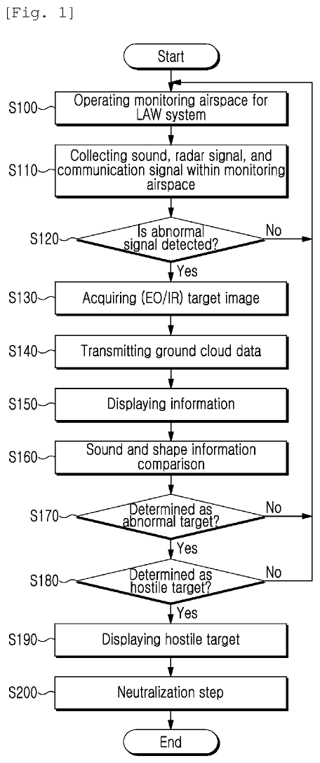

FIG. 1 is a conceptual flowchart illustrating operation of a low-altitude unmanned aerial vehicle warning system according to an embodiment.

As shown in FIG. 1, in a method of identifying and neutralizing an low-altitude unmanned aerial vehicle for a low-altitude unmanned aerial vehicle identification system a according to an embodiment of the disclosure, an aircraft identification information collection module sets monitoring airspace for a low altitude warning system at step S100. The monitoring airspace varies in distance and angle according to radar, a radio frequency detector, a camera, a sound detector. The monitoring airspace is set according to specification of the used sensor.

At step S110, by using the radar, the RF detector, the camera, and the sound detector, low-altitude unmanned aerial vehicle identification information that contains a radar signal, an RF signal, an image signal, and a sound signal is collected At step S120, when the identification information collected through the control module contains an abnormal signal, the abnormal signal is generated. When the abnormal signal is not contained, steps S100 and S110 are executed and low-altitude unmanned aerial vehicle identification information is collected by each sensor within the monitoring airspace.

At step S130, the control module is used to run a camera unit for taking an image of a target, when the abnormal signal is detected at step S120. In this case, the camera unit includes a heat sensing device to take an image of a target at night.

At step S140, the control module is used to transmit, to a ground control center, the collected low-altitude unmanned aerial vehicle identification information containing target image information obtained at step S130 and sound data.

At step S150, the control module is used to display a low-altitude unmanned aerial vehicle that generates the abnormal signal in a low-altitude air warning center, thereby enabling target observation.

At step S160, the control module is used to compare the low-altitude unmanned aerial vehicle identification information transmitted to the low-altitude air warning center with information stored in a database so that an appropriate response to the low-altitude unmanned aerial vehicle is performed.

At step S170, the control module is used to determine whether an abnormal target signal is included in the result of data processing. For example, a similarity degree between sound and shape information included in an unmanned aerial vehicle target image and prestored sound and shape information of each unmanned aerial vehicle type is less than a predetermined level, the unmanned aerial vehicle is determined as an abnormal target.

When the unmanned aerial vehicle is determined as the abnormal target, the control module is used to determine whether the unmanned aerial vehicle is a hostile target at step S180. For example, when the similarity degree between the sound and shape information included in the unmanned aerial vehicle target image and the prestored sound and shape information of each unmanned aerial vehicle type is less than the predetermined level, the unmanned aerial vehicle is determined as the abnormal target.

According to an embodiment of the disclosure, in a similarity degree determination method with respect to shape information, similarity means S(Iq, Id) is calculated for the determination. Here, Iq denotes an image obtained by a camera, and Id denotes an image in a database. The similarity means is a number that indicates how similar two images are. For example, the number 10 denotes that two images are the same, and the number 00 denotes that two images are completely different from each other. Usually, a distance is recognized as the inverse of the similarity. One example of similarity is the inverse of the distance between color histograms of two images. The color histogram is that an image characteristic is expressed in coordinates wherein the horizontal axis indicates a value of an image pixel and the vertical axis indicates the number of image pixels. That is, the color histogram is a graph that shows how many bright pixels and dark pixels are distributed in which image. The technique for the determination by comparison in image information using a color histogram is known in the related art, so a detailed description thereof will be omitted.

According to an embodiment of the disclosure, in a similarity degree determination method with respect to sound information, a fast Fourier transform (FFT) is used for the determination. The degree of a magnitude component for each frequency of a signal is obtained using Fourier transform. The FFT is an algorithm designed to quickly perform Fourier transform and inverse transform. A similarity degree is calculated by comparison in the magnitude value of each frequency component through the FFT. Similarly, the number 10 denotes that two sounds are the same, and the number 0 denotes that two sounds are completely different from each other. Comparing sound information by using the FFT is known in the related art, so a detailed description thereof will be omitted.

When a hostile target assurance signal is generated, the control module is used to display the low-altitude unmanned aerial vehicle which is the hostile target in the low-altitude air warning center at step S190. At step S200, the low-altitude unmanned aerial vehicle is neutralized through jamming and spoofing, which are electronic neutralization methods, or a physical neutralization method. The physical neutralization method will be described later. Regarding the electronic neutralization method, a pre-measure with the electronic neutralization method is followed by a post-measure with the physical neutralization method.

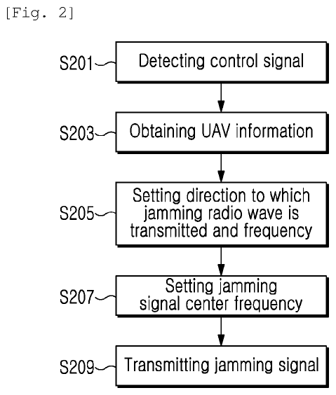

FIG. 2 is a flowchart illustrating jamming steps as a neutralization method according to an embodiment.

As shown in FIG. 2, in a method of identifying and neutralizing a low-altitude unmanned aerial vehicle according to an embodiment of the disclosure, a method of jamming a control signal of an unmanned aerial vehicle is disclosed as a step of neutralizing a drone which is a hostile target.

At step S201, a control signal receiver is used to detect a control signal by detecting PPM and PWM signals of the unmanned aerial vehicle or by detecting continuous change of an SSID of a wireless LAN for adjusting the unmanned aerial vehicle. When a wireless LAN-based signal is used as a control signal of an invading unmanned aerial vehicle, the invading unmanned aerial vehicle is equipped with a wireless LAN sharer having strong radio wave output. Therefore, when a wireless LAN-based signal is used as the control signal for the invading unmanned aerial vehicle, information on an SSID included in the wireless LAN-based signal keeps changing due to the flight of the invading unmanned aerial vehicle. Therefore, an invading unmanned aerial vehicle defence system is capable of detecting a control signal related to the invading unmanned aerial vehicle by detecting continuous change of an SSID and a change of SSID information in a wireless LAN signal.

When a PPM signal or a PWM signal is used as the control signal related to the invading unmanned aerial vehicle, the invading unmanned aerial vehicle needs to be always in a state in which networking with a pilot's controlling gear (or a controller) is possible. Thus, a predetermined number of pulses are detected every periodic time cycle. In general bi-directional communication, only when exchanging information, movement of a pulse is shown due to information loaded on a communication signal. When not exchanging information, only a checking signal for communication connection is transmitted every predetermined time cycle. However, the control signal related to the invading unmanned aerial vehicle uses uni-directional communication, so the invading unmanned aerial vehicle needs to be always connected with the controller. Further, the controller needs to always transmit information related to the flight of the invading unmanned aerial vehicle, so it is necessary to always transmit information without idle time. When communication between the controller and the invading unmanned aerial vehicle is disconnected, the invading unmanned aerial vehicle returns back to the initial take-off place or falls. Therefore, the control signal related to the invading unmanned aerial vehicle needs to have a predetermined number of pulses every predetermined time cycle.

At step S203, information on the unmanned aerial vehicle is obtained by detecting the control signal through the control module. At step S205, the frequency of the control signal is determined and the direction to which a jamming radio wave is transmitted and the frequency are set according to the obtained information at step S203 through the control module. Further, at step S207, the center frequency that corresponds to the frequency determined at step S203 through the control module is set to transmit a jamming signal corresponding thereto. The information described at step S203 means the position, the direction, and the like of the low-altitude unmanned aerial vehicle. Using the information at step S203, the direction in which a jamming signal is transmitted is set. At step S205, the direction in which the jamming signal is transmitted, and the like are set through the control module, thereby preparing to transmit the jamming signal. Further, at step S207, through the control module, the center frequency corresponding to the control signal is set with respect to the direction that is obtained at the above-described step, and the jamming signal having the center frequency is prepared to be transmitted. Last, at step S209, a transmitter is used to transmit the jamming signal having the frequency set at step S207 and the direction so as to try jamming the low-altitude unmanned aerial vehicle.

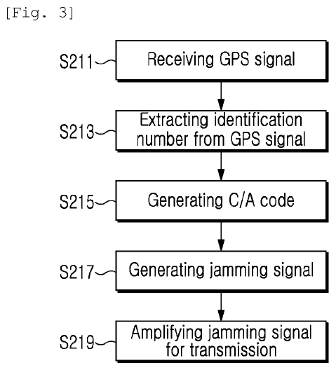

FIG. 3 is a flowchart illustrating steps of jamming a GPS signal as a neutralization method according to an embodiment.

As shown in FIG. 3, at step S211, the GPS signal receiver receives a GPS signal from a GPS satellite. At step S213, through the control module, an identification number of the GPS satellite is extracted from the received GPS signal and an NMEA message. The GPS receiver receives the GPS signal from the GPS satellite. The GPS satellite performs bandspread on 50 bps navigation data that contains its identification number, position, signal integrity, ionospheric information related to propagation environment, and the like, into a coarse/acquisition (C/A) pseudorandom noise (PRN) code at 1023 MHz so as to broadcast to the ground with the center frequency of 157542 Mhz for 24 hours.

The GPS signal receiver interprets the GPS signal and obtains a National Marine Electronics Association (NMEA) message that contains the identification number of the GPS satellite. A satellite number extracting part extracts the identification number of the GPS satellite from the GPS signal. That is, the NMEA message is received from the GPS receiver, and the identification number of the GPS satellite is extracted from the message.

At step S215, through the control module, a C/A code corresponding to the extracted identification number is generated. A C/A code generator generates a C/A code corresponding to the identification number of the GPS satellite which is extracted by the satellite number extracting part. The C/A code is a code transmitted from a GPS satellite, and each satellite has one of 32 unique codes. Each code consists of 1,023 chips and is transmitted at a rate of 1023 MB per second. The code repeats every 1/1000 seconds. The C/A code is transmitted on the L1 frequency (157542 MHz), and pseudorandom noise (PRN) of which the bandwidth is 1 MHz repeats. The PRN varies from satellite to satellite. Therefore, the C/A code is unique identification information of each satellite and is an index for identifying the satellite.

The C/A code generator 330 may have C/A codes corresponding to the identification numbers of respective satellites in advance, or may be provided with two linear feedback shift registers (LFSRs) and a tab selector in such a manner as to be capable of generating C/A codes corresponding to the identification numbers of respective satellites. The configuration of the C/A code generator 330 is already known in the related art, so a detailed description thereof will be omitted.

At step S217, through the control module, a first mixer is used to combine the C/A code with arbitrary jamming data so that a jamming signal is generated. The first mixer mixes the jamming data with the C/A code to generate a digital jamming signal of a baseband. Afterward, the jamming signal is converted to a higher frequency and is amplified for transmission at step S219. Here, a power amplifier is used for amplification, and an antenna is used for transmission.

According to general noise jamming, with respect to the entire band of the GPS signal, there is a band that cannot be jammed, and a high-power jamming signal is required. However, according to the jamming technique of the present invention, since a jamming signal is generated by mixing arbitrary jamming data with a C/A code that the actual GPS satellite uses, a jamming signal having the same spectrum as the GPS signal that the actual GPS satellite transmits is generated. Therefore, a relatively high-power jamming signal is not required.

The GPS receiver of the low-altitude unmanned aerial vehicle which receives the jamming signal according to the disclosure is unable to receive a normal GPS signal because the bandwidth of the GPS signal is the same as the bandwidth of the jamming signal. Therefore, the GPS receiver is unable to obtain its current position information.

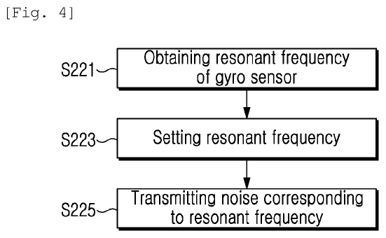

FIG. 4 is a flowchart illustrating steps of jamming a gyro sensor as a neutralization method according to an embodiment.

As shown in FIG. 4, at step S221, through the control module, a database is searched for a resonant frequency of a gyro sensor of the low-altitude unmanned aerial vehicle.

The gyro sensor is a device in which a gyro effect caused by rotation is used to inversely estimate the original position and to inversely compute the current direction. Thus, the gyro sensor is used to measure orientation. The gyro sensor is applied to a compass for a ship and an aircraft, a horizontal stabilizer of a large ship, an inertial guidance system of a rocket, and the like. The gyro sensor is a basic sensor that helps a low-altitude unmanned aerial vehicle to maintain its level.

The control center has already stored information on various types of low-altitude unmanned aerial vehicles. Thus, through the camera unit, the type of low-altitude unmanned aerial vehicle is obtained from shape and sound information, and the like of the low-altitude unmanned aerial vehicle, and specification information of the gyro sensor is stored, thereby obtaining the resonant frequency of the gyro sensor which may be used in jamming the gyro sensor. The resonance frequency of the gyro sensor is directly related to the structure of the gyro sensor.

At step S223, through the control module, setting resonance frequency of a transmitter is set in order to transmit a noise at the resonance frequency obtained at step S221.

At step S225, a noise corresponding to the found resonant frequency of the gyro sensor is amplified and transmitted by the transmitter. Neutralization and malfunction of the gyro sensor of the low-altitude unmanned aerial vehicle is induced by transmitting the noise corresponding to the resonant frequency of the gyro sensor, so that operation of the low-altitude unmanned aerial vehicle is prevented. That is, by transmitting such a noise, abnormal output from the gyro sensor is induced. In order to prevent abnormal output from the gyro sensor in daily life, the resonance frequency of the gyro sensor is generally designed to be 20 KHz or more. However, in some cases, abnormal output is reported even under 20 KHz.

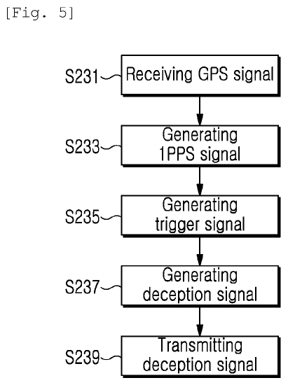

FIG. 5 is a flowchart illustrating steps of spoofing a GPS signal as a neutralization method according to an embodiment.

As shown in FIG. 5, when a navigation signal is received from the satellite by using the GPS signal receiver at step S231, a navigation signal receiving part distributes the received navigation signal evenly to a synchronization signal generating part and a navigation signal processing part. The synchronization signal generating part generates a 1PPS signal visually synchronized with the navigation signal by using a 1PPS signal generator at step S233. In addition, the synchronization signal generating part also outputs a clock signal at 10 MHz corresponding to a reference frequency of the navigation signal to generate a deception signal in which the navigation signal is synchronized with a clock frequency.

The 1PPS signal is output to a trigger generating part. When receiving a trigger signal generation command from a control part, in response thereto, the trigger generating part uses a trigger signal generator to generate a trigger signal corresponding to the start point in time of one pulse in a pulse string of the 1PPS signal at step S235. The trigger signal is in one pulse shape, wherein the amplitude of the trigger signal is determined according to the voltage level that is possibly input to a deception signal generating part.

The deception signal generating part uses a deception signal generator to generate a deception signal in response to the trigger signal input from the trigger generating part, thereby generating the deception signal visually synchronized with the navigation signal at step S237. Further, the deception signal generating part generates the deception signal according to the clock frequency of 10 MHz received from the synchronization signal generating part, thereby achieving synchronization with the clock frequency of the navigation signal.

A deception signal transmitting part uses a deception signal transmitter to transmit the deception signal at step S239.

As described above, in the method of generating a satellite navigation system deception signal according to the present invention, in response to gradual advancement of performance of the receiver against deception, generating a deception signal in which time and a clock frequency are synchronized with the navigation signal transmitted from the satellite causes the receiver to have difficulty in detecting the deception signal, so that deception success rate is enhanced.

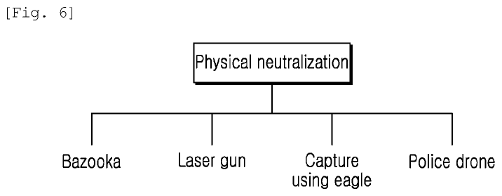

FIG. 6 is a diagram illustrating types of physical neutralization as a neutralization method according to an embodiment.

As shown in FIG. 6, means for intercepting a low-altitude unmanned aerial vehicle include physical interception means. In addition to jamming or spoofing shown in FIGS. 2, 3, 4, and 5, methods of capturing a drone physically, in which a bazooka is fired using a capture net; interceptor means with a laser beam is used; or a trained eagle is used, are used. Further, nowadays, due to the development of drone technology, research has been carried out to capture a low-altitude unmanned aerial vehicle using a so-called police drone with a net.

In the case of means for capturing using a net, a parachute is included to capture a drone safely so that information on the pilot and the drone is obtained to prepare terrorism, and the like in the future.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method of identifying and neutralizing a low-altitude unmanned aerial vehicle for a low-altitude unmanned aerial vehicle identification system including: a balloon main body filled with gas, the balloon main body having radar, an RF detector, a camera unit, a sound detector, a control module, and a neutralization device, the method comprising:
(A) setting monitoring airspace for a low altitude warning system and collecting low-altitude unmanned aerial vehicle identification information that contains a radar signal, an RF signal, an image signal, and a sound signal in the set monitoring airspace by using the radar, the RF detector, the camera unit, and the sound detector;
(B) determining, using the control module, whether an abnormal signal exceeding a predetermined level in prestored sound and shape information of each unmanned aerial vehicle type is contained in the collected identification information;
(C) taking, using the control module, when the abnormal signal is contained in the collected identification information, a low-altitude unmanned aerial vehicle target image of the low-altitude unmanned aerial vehicle that generates the abnormal signal, and transmitting the low-altitude unmanned aerial vehicle target image to a ground control center and a low-altitude air warning center;
(D) comparing, by the low-altitude air warning center using the control module, sound and shape information included in the unmanned aerial vehicle target image with the prestored sound and shape information of each unmanned aerial vehicle type;
(E) determining, using the control module, whether the unmanned aerial vehicle is an abnormal target according to a result of the comparison;
(F) checking, using the control module, when the unmanned aerial vehicle is determined as the abnormal target, whether the unmanned aerial vehicle is a hostile target;
(G) displaying, using the control module, when the abnormal target is hostile, the low-altitude unmanned aerial vehicle that is the hostile target in the low-altitude air warning center; and
(H) neutralizing, using the neutralization device, when the abnormal target is the hostile target, the low-altitude unmanned aerial vehicle that is the hostile target.

2. The method of claim 1, wherein the low-altitude unmanned aerial vehicle identification system includes: a control signal receiver for detecting a control signal, a transmitter transmitting a disturbance radio wave according to the control signal, and the control module setting a frequency of the transmitter, and
the (H) neutralizing of a drone that is the hostile target when the abnormal target is the hostile target comprises:
detecting, using the control signal receiver at a first step, a control signal by detecting PPM and PWM signals of the unmanned aerial vehicle or by detecting continuous change of an SSID of a wireless LAN for adjusting the unmanned aerial vehicle;
obtaining, through the control module at a second step, information on the unmanned aerial vehicle according to the control signal;
determining, through the control module at a third step, a frequency of the control signal and setting a direction to which a jamming radio wave is transmitted, according to the information obtained at the second step;
setting, through the control module at a fourth step, a center frequency of a jamming signal that corresponds to the frequency with respect to the direction of the unmanned aerial vehicle; and
transmitting, using the transmitter at a fifth step, the jamming signal that corresponds to the center frequency of the jamming signal with respect to the direction obtained at the third step.

3. The method of claim 1, wherein the low-altitude unmanned aerial vehicle identification system includes: a GPS signal receiver receiving a GPS signal from a GPS satellite, the control module extracting an identification number from the GPS signal and generating a C/A code corresponding to the identification number, a signal generator mixing the C/A code with arbitrary jamming data, and a transmitter transmitting a signal generated by the signal generator, and
the (H) neutralizing of a drone that is the hostile target when the abnormal target is the hostile target comprises:
receiving, through the GPS signal receiver at a first step, the GPS signal from the GPS satellite;
extracting, through the control module at a second step, the identification number of the GPS satellite from the received GPS signal and an NMEA message;
generating, through the control module at a third step, the C/A code corresponding to the extracted identification number;
generating, using the signal generator and a first mixer at a fourth step, a jamming signal by mixing the C/A code with the arbitrary jamming data; and
converting, at a fifth step, the jamming signal to a higher frequency and amplifying and transmitting the resulting signal by using the transmitter.

4. The method of claim 2, wherein the low-altitude unmanned aerial vehicle identification system includes: a GPS signal receiver receiving a GPS signal from a GPS satellite, the control module extracting an identification number from the GPS signal and generating a C/A code corresponding to the identification number, a signal generator mixing the C/A code with arbitrary jamming data, and a transmitter transmitting a signal generated by the signal generator, and
the (H) neutralizing of a drone that is the hostile target when the abnormal target is the hostile target comprises:
receiving, through the GPS signal receiver at a first step, the GPS signal from the GPS satellite;
extracting, through the control module at a second step, the identification number of the GPS satellite from the received GPS signal and an NMEA message;
generating, through the control module at a third step, the C/A code corresponding to the extracted identification number;
generating, using the signal generator and a first mixer at a fourth step, a jamming signal by mixing the C/A code with the arbitrary jamming data; and
converting, at a fifth step, the jamming signal to a higher frequency and amplifying and transmitting the resulting signal by using the transmitter.

5. The method of claim 1, wherein the low-altitude unmanned aerial vehicle identification system includes: the control module searching for a resonant frequency of a gyro sensor of the low-altitude unmanned aerial vehicle which is the hostile target, and a transmitter transmitting the resonance frequency found by the control module, and
the (H) neutralizing of a drone that is the hostile target when the abnormal target is the hostile target comprises:
searching, through the control module at a first step, a database for the resonance frequency of the gyro sensor of the low-altitude unmanned aerial vehicle which is the hostile target; and
amplifying, at a second step, a noise corresponding to the found resonant frequency of the gyro sensor and transmitting the noise through the transmitter.

6. The method of claim 4, wherein the low-altitude unmanned aerial vehicle identification system includes: the control module searching for a resonant frequency of a gyro sensor of the low-altitude unmanned aerial vehicle which is the hostile target, and the transmitter transmitting the resonance frequency found by the control module, and
the (H) neutralizing of a drone that is the hostile target when the abnormal target is the hostile target comprises:
searching, through the control module at a first step, a database for the resonance frequency of the gyro sensor of the low-altitude unmanned aerial vehicle which is the hostile target; and
amplifying, at a second step, a noise corresponding to the found resonant frequency of the gyro sensor and transmitting the noise through the transmitter.

7. The method of claim 1, wherein the low-altitude unmanned aerial vehicle identification system includes: a GPS signal receiver, a 1PPS signal generator, a trigger signal generator, a deception signal generator, and a deception signal transmitter, and
the (H) neutralizing of a drone that is the hostile target when the abnormal target is the hostile target comprises:
receiving, using the GPS signal receiver at a first step, a GPS signal transmitted from a satellite;
generating, using the 1PPS signal generator at a second step, a 1PPS signal synchronized with the GPS signal;
generating, using the trigger signal generator at a third step, a trigger signal for generating a deception signal that is synchronized with the GPS signal on the basis of the 1PPS signal;
generating, using the deception signal generator at a fourth step, the deception signal that is visually synchronized with the GPS signal in response to the trigger signal and is synchronized with a clock frequency of the GPS signal; and
transmitting, using the deception signal transmitter at a fifth step, the deception signal.

8. The method of claim 2, wherein the low-altitude unmanned aerial vehicle identification system includes: a GPS signal receiver, a 1PPS signal generator, a trigger signal generator, a deception signal generator, and a deception signal transmitter, and
the (H) neutralizing of a drone that is the hostile target when the abnormal target is the hostile target comprises:
receiving, using the GPS signal receiver at a first step, a GPS signal transmitted from a satellite;
generating, using the 1PPS signal generator at a second step, a 1PPS signal synchronized with the GPS signal;
generating, using the trigger signal generator at a third step, a trigger signal for generating a deception signal that is synchronized with the GPS signal on the basis of the 1PPS signal;
generating, using the deception signal generator at a fourth step, the deception signal that is visually synchronized with the GPS signal in response to the trigger signal and is synchronized with a clock frequency of the GPS signal; and
transmitting, using the deception signal transmitter at a fifth step, the deception signal.

9. The method of claim 4, wherein the low-altitude unmanned aerial vehicle identification system includes: the GPS signal receiver, a 1PPS signal generator, a trigger signal generator, a deception signal generator, and a deception signal transmitter, and
the (H) neutralizing of a drone that is the hostile target when the abnormal target is the hostile target comprises:
receiving, using the GPS signal receiver at a first step, the GPS signal transmitted from a satellite;
generating, using the 1PPS signal generator at a second step, a 1PPS signal synchronized with the GPS signal;
generating, using the trigger signal generator at a third step, a trigger signal for generating a deception signal that is synchronized with the GPS signal on the basis of the 1PPS signal;
generating, using the deception signal generator at a fourth step, the deception signal that is visually synchronized with the GPS signal in response to the trigger signal and is synchronized with a clock frequency of the GPS signal; and
transmitting, using the deception signal transmitter at a fifth step, the deception signal.

10. The method of claim 6, wherein the low-altitude unmanned aerial vehicle identification system includes: the GPS signal receiver, a 1PPS signal generator, a trigger signal generator, a deception signal generator, and a deception signal transmitter, and
the (H) neutralizing of a drone that is the hostile target when the abnormal target is the hostile target comprises:
receiving, using the GPS signal receiver at a first step, the GPS signal transmitted from a satellite;
generating, using the 1PPS signal generator at a second step, a 1PPS signal synchronized with the GPS signal;
generating, using the trigger signal generator at a third step, a trigger signal for generating a deception signal that is synchronized with the GPS signal on the basis of the 1PPS signal;
generating, using the deception signal generator at a fourth step, the deception signal that is visually synchronized with the GPS signal in response to the trigger signal and is synchronized with a clock frequency of the GPS signal; and
transmitting, using the deception signal transmitter at a fifth step, the deception signal.

11. The method of claim 1, further comprising:
a physical neutralization step of the low-altitude unmanned aerial vehicle.

12. The method of claim 2, further comprising:
a physical neutralization step of the low-altitude unmanned aerial vehicle.

13. The method of claim 4, further comprising:
a physical neutralization step of the low-altitude unmanned aerial vehicle.

14. The method of claim 8, further comprising:
a physical neutralization step of the low-altitude unmanned aerial vehicle.

15. The method of claim 9, wherein the low-altitude unmanned aerial vehicle identification system includes the control module for computing similarity, and
the (B) determining of whether the abnormal signal is contained in the collected identification information comprises:
comparing, using the control module, the sound and shape information of each unmanned aerial vehicle type stored in a database with the collected unmanned aerial vehicle identification information and determining a signal having similarity less than the predetermined level in the sound and shape information as the abnormal signal.

16. The method of claim 10, wherein the low-altitude unmanned aerial vehicle identification system includes the control module for computing similarity, and
the (B) determining of whether the abnormal signal is contained in the collected identification information comprises:
comparing, using the control module, the sound and shape information of each unmanned aerial vehicle type stored in the database with the collected unmanned aerial vehicle identification information and determining a signal having similarity less than the predetermined level in the sound and shape information as the abnormal signal.

17. The method of claim 11, wherein the low-altitude unmanned aerial vehicle identification system includes the control module for computing similarity, and
the (B) determining of whether the abnormal signal is contained in the collected identification information comprises:
comparing, using the control module, the sound and shape information of each unmanned aerial vehicle type stored in a database with the collected unmanned aerial vehicle identification information and determining a signal having similarity less than the predetermined level in the sound and shape information as the abnormal signal.

18. The method of claim 12, wherein the low-altitude unmanned aerial vehicle identification system includes the control module for computing similarity, and
the (B) determining of whether the abnormal signal is contained in the collected identification information comprises:
comparing, using the control module, the sound and shape information of each unmanned aerial vehicle type stored in a database with the collected unmanned aerial vehicle identification information and determining a signal having similarity less than the predetermined level in the sound and shape information as the abnormal signal.
